(19) United States
(12) Patent Application Publication
(10) Pub. No.: US 2026/0140381 A1
(43) Pub. Date: May 21, 2026

(54) Three-Dimensional Display Device and Display Driving Method

(71) Applicant: LG Display Co., Ltd., Seoul (KR)

(72) Inventor: ByoungGwan Lee, Paju-si (KR)

(21) Appl. No.: 19/319,056

(22) Filed: Sep. 4, 2025

(30) Foreign Application Priority Data
Nov. 21, 2024 (KR) 10-2024-0167126

(51) Int. Cl. G02B 27/01; G02B 27/00; G09G 3/00

(52) U.S. Cl. CPC G02B 27/0172; G02B 27/0075; G02B 27/0093; G09G 3/003; G02B 2027/0138; G09G 2300/0819; G09G 2310/08; G09G 2330/021

(57) ABSTRACT

A three-dimensional (3D) display device may comprise a display panel including a plurality of subpixels, a variable focus lens positioned in a front position of the display panel, an optical lens positioned in a front position of the variable focus lens, a gaze detector detecting a gaze of a user positioned in the front position of the display panel to generate a gaze detection signal, an object controller generating an object information signal for an object displayed on the display panel, and a focus control circuit controlling a focus of the variable focus lens based on an emission control signal, the gaze detection signal, and the object information signal.

### CROSS-REFERENCE TO RELATED APPLICATION

This application claims priority from Republic of Korea Patent Application No. 10-2024-0167126 filed on Nov. 21, 2024, which is hereby incorporated by reference in its entirety.

### BACKGROUND

### Field

Embodiments of the disclosure relate to a three-dimensional (3D) display device and a display driving method.

### Description of Related Art

As information technology develops, the market for display devices, which are user-to-information connecting media, is growing. Accordingly, various display devices, such as organic light emitting display (OLED), quantum dot display (QDD), liquid crystal display (LCD), and plasma display panel (PDP), are increasingly used.

The display device includes a display panel where a plurality of subpixels are arranged, and various driving circuits such as a data driving circuit and a gate driving circuit for driving the display panel. In the display panel of the display device, transistors, various electrodes, various signal lines, and the like are formed on a glass substrate, and the driving circuits that may be implemented as integrated circuits are mounted on a printed circuit and are electrically connected to the display panel through the printed circuit. However, this conventional structure is suitable for large display devices, but not for small display devices.

In particular, with the recent distribution of three-dimensional (3D) content, 3D display devices are being actively adopted. Most of the 3D display devices currently commercially available are head-mounted displays (HMDs).

The head-mounted display device is a glasses-type monitor device that is worn in the form of glasses or a helmet to form a focus close to the user's eyes, and enables virtual reality with a virtual image implemented through a computer screen device in the form of a head-mounted display, or enables augmented reality by delivering actual environmental information to the user, or superposing a 3D virtual image with the real environment viewed by the user in real-time.

Meanwhile, since these 3D display devices provide a limited sense of depth by focusing, which causes a vergence accommodation conflict (VAC) issue. In this case, the vergence accommodation conflict refers to a phenomenon in which the user's focus is fixed on the display screen, while the depth perceived through the virtual image is formed at the front and rear positions of the display screen, causing inconsistency in the control operation for vergence and focus.

This vergence accommodation conflict may cause symptoms such as eye fatigue, dizziness, or vomiting in the user. In particular, in the case of presbyopia or low vision, where the ability of the eye to adjust focus is diminished, it may be difficult to quickly recognize virtual images, thereby potentially intensifying fatigue and dizziness due to vergence-accommodation conflict.

### SUMMARY

Embodiments of the disclosure may provide a 3D display device and a display driving method capable of reducing the influence of vergence accommodation conflict.

Embodiments of the disclosure may provide a 3D display device and a display driving method capable of reducing the influence of vergence accommodation conflict by controlling the focus of the variable focus lens in the non-emission period of the display panel.

Embodiments of the disclosure may provide a 3D display device and a display driving method capable of reducing the influence of vergence accommodation conflict by controlling a margin between the timing when the focus of the variable focus lens is controlled and the emission period according to the distance of the object recognized by the user.

Objects of embodiments of the disclosure are not limited to those set forth herein, and other unmentioned objects would be apparent to one of ordinary skill in the art from the following description.

In one embodiment, a display device that displays a three-dimensional image, comprises: a display panel including a plurality of subpixels; a variable focus lens located in a front position of the display panel; an optical lens located in a front position of the variable focus lens such that the variable focus lens is between the display panel and the optical lens; a gaze detector configured to detect a user's gaze of the display panel and generate a gaze detection signal based on the detection; an object controller configured to generate an object information signal corresponding to an object displayed on the display panel; and a focus control circuit configured to control a focus of the variable focus lens based on an emission control signal, the gaze detection signal, and the object information signal.

In one embodiment, a display driving method for driving a display panel including a plurality of subpixels, the display driving method comprising: detecting a user's gaze and generating a gaze detection signal based on the detection; synchronizing the gaze detection signal with a vertical synchronization signal and generating a gaze synchronization signal; generating an object information signal for an object displayed on the display panel using the gaze synchronization signal; and controlling a focus of a variable focus lens during a non-emission period of one frame based on an emission control signal, the gaze detection signal, and the object information signal. In one embodiment, a display device that displays a three-dimensional image, the display device comprising: a display panel including a plurality of subpixels that display an object; an optical lens; a variable focus lens between the display panel and the optical lens; and a gaze detector configured to detect a user's gaze of the object displayed by the display panel, wherein a state of the variable focus lens is changed according to the detected user's gaze which changes a focus of the variable focus lens.

According to embodiments of the disclosure, there may be provided a 3D display device and a display driving method capable of reducing power consumption and enhancing image quality by reducing the influence of vergence accommodation conflict with low power.

According to embodiments of the disclosure, there may be provided a 3D display device and a display driving method capable of reducing the effect of vergence accommodation conflict by controlling the focus of the variable focus lens in the non-emission period of the display panel.

According to embodiments of the disclosure, there may be provided a 3D display device and a display driving method capable of reducing the effect of vergence accommodation conflict by controlling a margin between the timing when the focus of the variable focus lens is controlled and the emission period according to the distance of the object recognized by the user.

The effects of the disclosure are not limited to the foregoing objects, and other effects will be apparent to one of ordinary skill in the art from the following detailed description.

### BRIEF DESCRIPTION OF DRAWINGS

The disclosure will be more fully understood from the following detailed description and the accompanying drawings, which are provided for illustration only and are not intended to limit the disclosure:

FIG. 1 is a view schematically illustrating a display device according to various embodiments of the disclosure;

FIG. 2 is a view illustrating an example of a structure of a 3D display device according to embodiments of the disclosure;

FIGS. 3A and 3B are example views illustrating a vergence accommodation conflict phenomenon of a 3D display device;

FIG. 4 is a view schematically illustrating a configuration of a 3D display device according to embodiments of the disclosure;

FIG. 5 is a view illustrating one example of a subpixel equivalent circuit in a 3D display device according to embodiments of the disclosure;

FIG. 6 is an example signal waveform view illustrating an operation of a subpixel in a display driving section in which image data is displayed in a 3D display device according to embodiments of the disclosure;

FIG. 7 is a view illustrating an equivalent circuit of another subpixel that may be included in a 3D display device according to embodiments of the disclosure;

FIG. 8 is an example signal waveform view illustrating an operation of the subpixel of FIG. 7 according to embodiments of the disclosures;

FIG. 9 is a block diagram illustrating a detailed system configuration of a 3D display device according to embodiments of the disclosure;

FIGS. 10A, 10B, and 10C are conceptual views illustrating cases in which a variable focus lens is controlled according to a depth of an object to which the user's gaze is directed in a 3D display device according to embodiments of the disclosure ;

FIG. 11 is a signal flowchart illustrating a case in which a 3D display device according to embodiments of the disclosure operates in a global shutter method;

FIG. 12 is a view illustrating a method for controlling a focus when a 3D display device operates in a global shutter method according to embodiments of the disclosure;

FIG. 13 is a signal flowchart illustrating a case in which a 3D display device operates in a rolling shutter method according to embodiments of the disclosure; and

FIG. 14 is a view illustrating a method for controlling a focus when a 3D display device operates in a rolling shutter method according to embodiments of the disclosure.

### DETAILED DESCRIPTION

Hereinafter, some embodiments of the disclosure will be described in detail with reference to exemplary drawings. In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the disclosure will be described in detail with reference to the accompanying drawings.

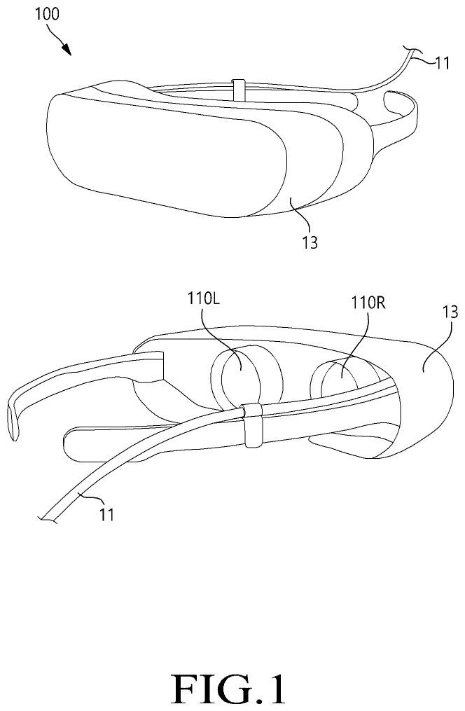

FIG. 1 is a view schematically illustrating a 3D display device according to various embodiments of the disclosure.

Referring to FIG. 1, the three-dimensional (3D) display device 100 according to embodiments of the disclosure may be a display device capable of displaying an image of virtual reality (VR), augmented reality (AR), extended reality (XR), or mixed reality (MR). For example, the 3D display device 100 of the disclosure may include a head mounted display (HMD)-type device, which is a type of wearable device.

The 3D display device 100 may include an image signal input unit 11 to which image data is input, a first display panel 110L on which a first image (e.g., a left-eye image) based on an image signal is displayed, a second display panel 110R on which a second image (e.g., a right-eye image) based on an image signal is displayed, and a case 13.

The image signal input unit 11 may include a wired cable or a wireless communication module (e.g., a circuit) connected to a host system (e.g., a smartphone, a laptop, etc.) that outputs image data. Here, although the image signal input unit 11 is illustrated as a wired line, the image signal input unit 11 may be implemented as a wireless interface circuit.

The first display panel 110L and the second display panel 110R are formed at positions corresponding to the user's left eye and right eye. The combination of the first display panel 110L, the second display panel 110R, and a driving circuit for driving them may be referred to as the 3D display device 100.

Further, the 3D display device 100 of the disclosure may include two display panels 110R and 110L, but may also include a display device that may display an image in a virtual space through one display panel.

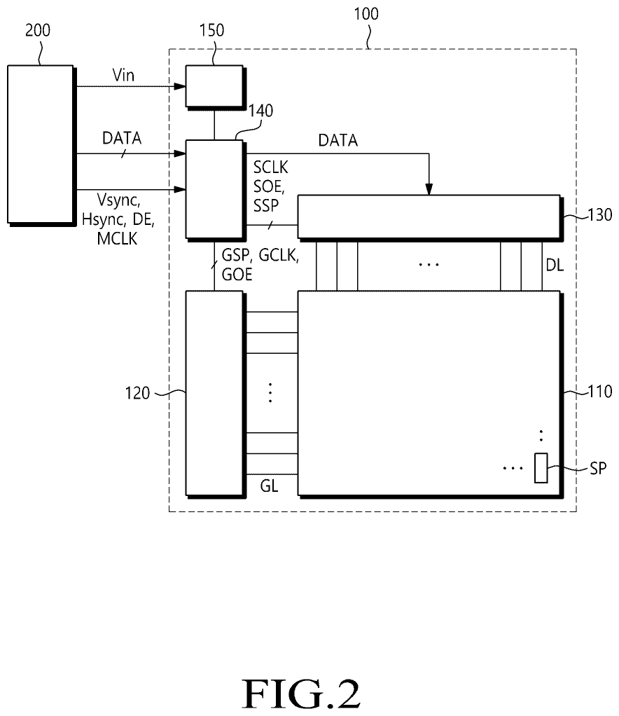

FIG. 2 is a view illustrating an example of a structure of a 3D display device according to embodiments of the disclosure.

Referring to FIG. 2, a three-dimensional (3D) display device 100 according to embodiments of the disclosure may include a display panel 110 where a plurality of gate lines GL and data lines DL are connected, and a plurality of subpixels SP are arranged in a matrix form, a gate driving circuit 120 for driving the plurality of gate lines GL, a data driving circuit 130 for supplying a data voltage through the plurality of data lines DL, a timing controller 140 for controlling the gate driving circuit 120 and the data driving circuit 130, and a power management circuit 150.

The display panel 110 displays an image, in the display area, based on a gate signal transmitted from the gate driving circuit 120 through the plurality of gate line GLs GL and the data voltage transmitted from the data driving circuit 130 through the plurality of data lines DL.

The gate signals transmitted from the gate driving circuit 120 may include a scan signal used as a control signal for driving the subpixel, an emission signal used as a control signal for the operation of the light emitting element, or a sensing signal used as a control signal for sensing the voltage of a specific node.

In the display panel 110, a plurality of pixels may be arranged in a matrix form, and each pixel may include subpixels SP having different colors, e.g., a white subpixel, a red subpixel, a green subpixel, and a blue subpixel, and each subpixel SP may be defined by the plurality of data lines DL and the plurality of gate lines GL.

One subpixel SP may include a thin film transistor (TFT) formed in an area where one data line DL and one gate line GL intersect, a light emitting element such as a micro LED that emits light according to a data voltage, a storage capacitor electrically connected to the light emitting element to maintain a voltage, and the like.

For example, when the display device 100 having a resolution of 2,800×1,290 includes four subpixels SP of red R), green G), and blue B), 1,290 data lines DL may be connected to 2,800 gate lines GL and three subpixels RGB, and thus, there may be provided 1,290×3=3,870 data lines DL. Each subpixel SP is disposed at the intersection between the gate line GL and the data line DL.

The gate driving circuit 120 may be controlled by the timing controller 140 to sequentially output gate signals to the plurality of gate lines GL disposed in the display panel 110, controlling the driving timing of the plurality of subpixels SP.

In the display device 100 having a resolution of 2,800×1,290, sequentially outputting the gate signal to the 2,800 gate lines GL from the first gate line to the 2,160th gate line may be referred to as 2,800-phase driving. Or, when gate signals are sequentially output on a per-four gate line GL basis, like when gate signals are sequentially output from the first gate line to the fourth gate line and then gate signals are sequentially output from the fifth gate line to the eight gate line, is referred to as four-phase driving. In other words, when gate signals are sequentially output every N gate lines GL may be referred to as N-phase driving.

The gate driving circuit 120 may include one or more gate driving integrated circuits (GDICs). Depending on driving schemes, the gate driving circuit 120 may be positioned on only one side, or each of two opposite sides, of the display panel 110. The gate driving circuit 120 may be implemented in a gate-in-panel (GIP) form which is embedded in the bezel area of the display panel 110.

The data driving circuit 130 receives image data DATA from the timing controller 140 and converts the received image data DATA into an analog data voltage. Then, as the data voltage is output to each data line DL according to the timing when the gate signal is applied through the gate line GL, each subpixel SP connected to the data line DL receives a data signal having the brightness corresponding to the data voltage.

Likewise, the data driving circuit 130 may include one or more source driving integrated circuits SDIC, and the source driving integrated circuit SDIC may be connected to the bonding pad of the display panel 110 in a tape automated bonding (TAB) type or a chip-on-glass (COG) type or may be disposed directly on the display panel 110.

In some cases, each source driving integrated circuit SDIC may be integrated and disposed on the display panel 110. Further, each source driving integrated circuit SDIC may be implemented in a chip-on-film (COF) type and, in this case, each source driving integrated circuit SDIC may be mounted on a circuit film and may be electrically connected to the data line DL of the display panel 110 through the circuit film.

The timing controller 140 supplies various control signals to the gate driving circuit 120 and the data driving circuit 130 and controls the operation of the gate driving circuit 120 and the data driving circuit 130. In other words, the timing controller 140 may control the gate driving circuit 120 to output a gate signal according to the timing implemented in each frame and, on the other hand, transfers the image data DATA received from the outside to the data driving circuit 130.

In this case, the timing controller 140 receives, from an external host system 200, several timing signals including, e.g., a vertical synchronization signal Vsync, a horizontal synchronization signal Hsync, a data enable signal DE, and a main clock MCLK, together with the image data DATA.

The host system 200 may be any one of a television (TV) system, a set-top box, a navigation system, a personal computer (PC), a home theater system, a mobile device, and a wearable device.

Accordingly, the timing controller 140 may generate a control signal according to various timing signals received from the host system 200 and transfers the control signal to the gate driving circuit 120 and the data driving circuit 130.

For example, the timing controller 140 outputs several gate control signals including, e.g., a gate start pulse GSP, a gate clock GCLK, and a gate output enable signal GOE, to control the gate driving circuit 120. The gate start pulse GSP controls the timing at which one or more gate driving integrated circuits GDIC constituting the gate driving circuit 120 start operation. The gate clock GCLK is a clock signal commonly input to one or more gate driving integrated circuits GDIC and controls the shift timing of the gate signal. The gate output enable signal GOE designates timing information about one or more gate driving integrated circuits GDICs.

The timing controller 140 outputs various data control signals including, e.g., a source start pulse SSP, a source clock SCLK, and a source output enable signal SOE, to control the data driving circuit 130. The source start pulse SSP controls the timing at which one or more source driving integrated circuits SDIC constituting the data driving circuit 130 start data sampling. The source clock SCLK is a clock signal that controls the timing of sampling data in the source driving integrated circuit SDIC. The source output enable signal SOE controls the output timing of the data driving circuit 130.

The display device 100 may further include a power management circuit 150 that supplies various voltages or currents to, e.g., the display panel 110, the gate driving circuit 120, and the data driving circuit 130 or controls various voltages or currents to be supplied.

The power management circuit 150 adjusts the direct current (DC) input voltage Vin supplied from the host system 200, generating power required to drive the display panel 100, the gate driving circuit 120, and the data driving circuit 130.

The subpixel SP is positioned at the intersection between the gate line GL and the data line DL, and a light emitting element may be disposed in each subpixel SP. For example, the micro LED display device may include a light emitting element, such as a micro LED, in each subpixel SP and may display an image by controlling the current flowing to the light emitting element according to the data voltage.

The display panel 110 may be various types of devices such as a micro LED display panel, a liquid crystal display panel, an organic light emitting display panel, and a plasma display panel.

Since the 3D display device 100 is limited in providing a sense of depth by focusing, it may cause a vergence accommodation conflict (VAC) issue.

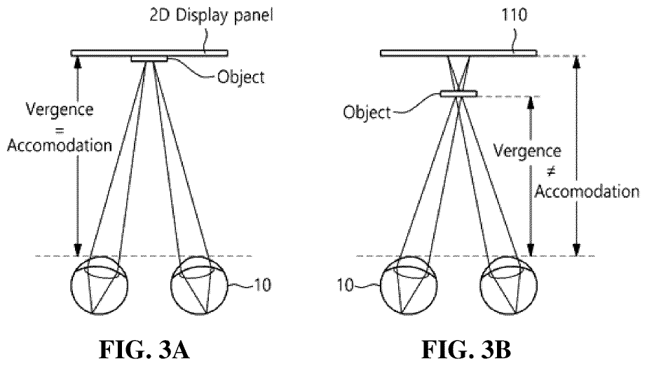

FIGS. 3A and 3B are example views illustrating a vergence accommodation conflict phenomenon of a 3D display device.

Referring to FIG. 3, the vergence accommodation conflict of the 3D display device 100 means a phenomenon in which the accommodation action for vergence and the focus are inconsistent as the user's focus is fixed on the display panel 110 while the sense of depth perceived through the virtual image is formed at a position before/after the display panel 110.

The angle when the user's eyeballs 10 viewing an object in a short range is larger than the angle when viewing an object in a long range. In other words, both eyeballs 10 of the user may operate to converge (vergence) inward towards the facial midline when viewing a nearby object, and conversely, may become nearly parallel to the facial midline when viewing an object positioned at a distance.

In this case, the user's eyeballs 10 adjusts (accommodation) the shape and thickness of the lens to focus on an object positioned at a specific distance. Thus, the user's eyeball 10 may obtain a clear image of an object by thickening the lens when focusing on an object located at a close distance, and by thinning the lens when focusing on an object located at a long distance.

As such, the eyeballs 10 of the user may obtain a clear image regardless of the distance at which an object is placed through the operation (accommodation) of adjusting the shape and thickness of the lens.

Referring to the case of FIG. 3A, the user's eyeballs 10 may exhibit the same vergence and accommodation distance when viewing an image through a typical two-dimensional (2D) display panel.

However, as in the case of FIG. 3B, in the case of the 3D display device 100 using binocular disparity, inconsistency occurs in the vergence-accommodation states having interdependence.

In this case, the user's eyeball 10 may adjust (accommodation) the lens to focus on the display panel 110.

On the other hand, since the object displayed as a 3D image in the virtual space is shown as if it is in front of the display panel 110, the user's eyeballs 10 adjusts the lens to converge (vergence) on the object displayed in front of the display panel 110. At the same time, the user's eyeballs 10 attempt to focus on the display panel 110 to obtain a clear image.

In other words, while the accommodation distance of the eyeballs 10 is constant up to the display panel 110, the vergence distance to the object in the virtual space may vary, resulting in an inconsistency between vergence and accommodation which are interdependent. As a result, the brain interpreting the image input through the user's eyeballs 10 feels confused, causing symptoms such as eye fatigue, dizziness, or vomiting.

In order to mitigate the vergence accommodation conflict, the 3D display device 100 of the disclosure may include a variable focus lens that identifies an object gazed at by the user's eyeballs 10 and changes the focus according to the distance to the object gazed at by the eyeballs 10.

Further, the 3D display device 100 of the disclosure may control the timing of changing the focus on the object gazed at by the user's eyes 10 within a 3D image to occur during a non-emission period, thereby preventing or reducing the image blurring or unstable focusing.

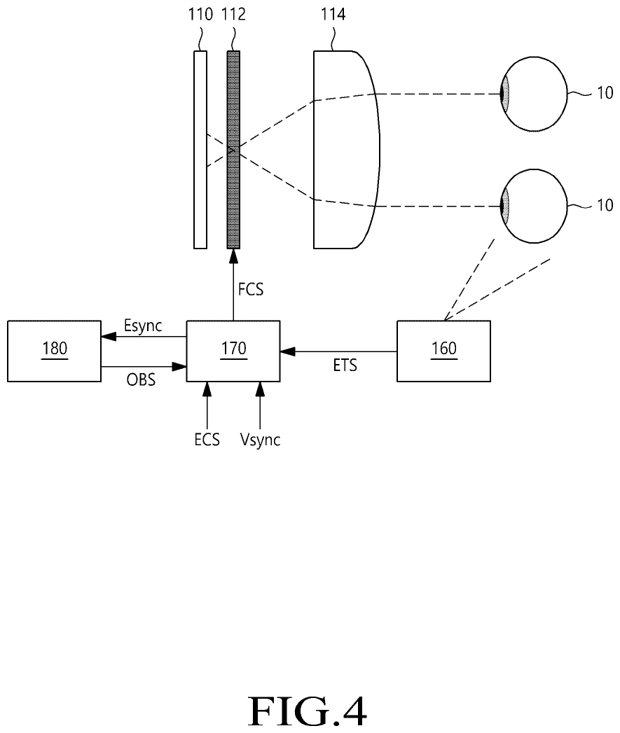

FIG. 4 is a view schematically illustrating a configuration of a 3D display device according to embodiments of the disclosure.

Referring to FIG. 4, the 3D display device 100 according to embodiments of the disclosure may include a display panel 110 displaying an image, a variable focus lens 112, and an optical lens 114.

The variable focus lens 112 is positioned in front of the display panel 110 to control the focus of the user's eyeball 10 on the image displayed by the display panel 110. Generally, the state of the variable focus lens 112 can change.

For example, the variable focus lens 112 may include an Alvarez lens that adjusts the focus by mechanically moving two lenses with a cubic surface horizontally which is an example of a state of the variable focus lens 112, a liquid lens that adjusts the focus using the thickness of a liquid which is an example of a state of the variable focus lens 112, a liquid crystal gradient index (GRIN) lens that adjusts the focus by spatially changing the refractive index of the liquid crystal with an electric field which is an example of a state of the variable focus lens 112, or a geometric phase lens that adjusts the focus using a phase change based on polarization which is an example of a state of the variable focus lens 112.

The optical lens 114 serves to adjust the interval of an image incident into the user's eyeball 10 through the variable focus lens 112 to be within the diameter of the eyeball 10.

For example, the optical lens 114 may be a Fresnel lens in the form of a plastic plate, including a first surface facing the user's eyeballs 10 and a second surface facing the variable focus lens 112.

In the process of changing the focus according to the distance to the object gazed at by the user's eyeball 10 through the variable focus lens 112, the 3D display device 100 of the disclosure controls the focus change timing to be included in the non-emission period, preventing or reducing the image blurring or unstable focusing.

To this end, the 3D display device 100 of the disclosure may include a gaze detector 160, a focus control circuit 170, and an object controller 180 (e.g., circuit).

The gaze detector 160 is a part that detects the user's gaze and generates a gaze detection signal ETS.

To this end, the gaze detector 160 may include a camera that captures the user's eyeball 10 and an eye-tracking circuit (eye-tracker) that generates a gaze detection signal ETS from the user's eye image captured by the camera.

The focus control circuit 170 may synchronize the gaze detection signal ETS transmitted from the gaze detector 160 with the image using the vertical synchronization signal Vsync to generate the gaze synchronization signal Esync.

The object controller 180 may generate an object information signal OBS including information for depth and position of an object where the user's gaze is positioned using the gaze synchronization signal Esync.

The focus control circuit 170 may generate a focus control signal FCS based on the object information signal OBS generated by the object controller 180 and control the focus of the variable focus lens 112 (e.g., the thickness of the variable focus lens 112), thereby reducing issues such as dizziness, eye fatigue, and vomiting caused by vergence-accommodation conflict (VAC).

Here, the gaze detector 160, the focus control circuit 170, and the object controller 180 may be included in the timing controller 140.

Alternatively, the gaze detector 160 and the object controller 180 may be included in the host system 200, and the focus control circuit 170 may be included in the timing controller 140.

Further, at least one of the gaze detector 160, the focus control circuit 170, and the object controller 180 may be separately formed on the printed circuit board in the form of an integrated circuit.

In this case, the 3D display device 100 of the disclosure may prevent or at least reduce a phenomenon in which the image perceived by the user is blurred or the focus is unstable by controlling the focus change to be performed within the non-emission period using the focus control signal (FCS) that controls the variable focus lens 112.

To this end, the focus control circuit 170 may receive an emission control signal ECS for controlling the emission period of the display panel 110. In this case, the emission control signal ECS may vary according to the structure of the subpixel SP.

Further, an example in which the 3D display device 100 includes one display panel 110 and one variable focus lens 112 is illustrated herein, so that one focus control circuit 170 is disclosed. However, when a first display panel for displaying an image on the left eye and a second display panel for displaying an image on the right eye are included, two variable focus lenses 112 and two focus control circuits 170 may be configured corresponding to the display panels, respectively.

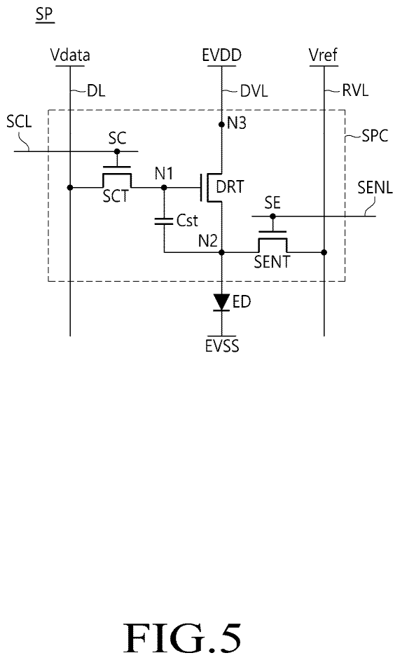

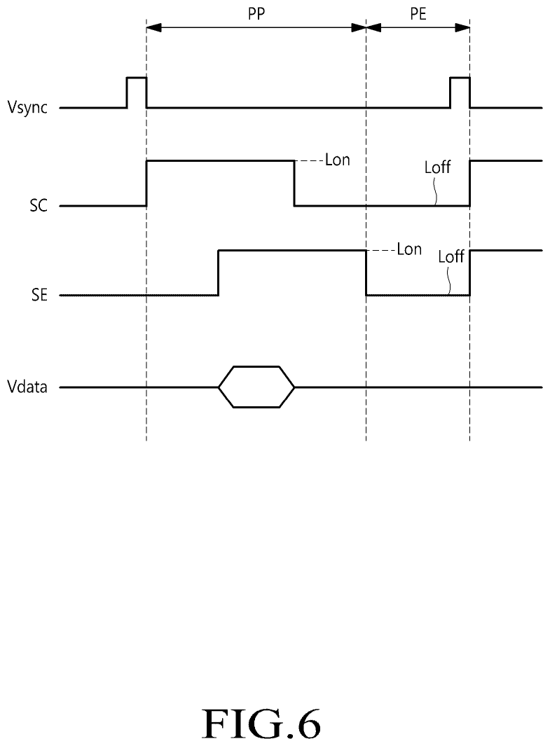

FIG. 5 is a view illustrating an example of a subpixel equivalent circuit in a 3D display device according to embodiments of the disclosure, and FIG. 6 is an example signal waveform view illustrating an operation of a subpixel in a display driving period when image data is displayed in a 3D display device according to embodiments of the disclosure.

Referring to FIG. 5, when the 3D display device 100 according to embodiments of the disclosure is a self-emissive display, each of the plurality of subpixels SP disposed on the display panel 110 may include a light emitting element ED and a subpixel circuit SPC for driving the light emitting element ED.

The subpixel circuit SPC of each subpixel SP may include a driving transistor DRT, a scan transistor SCT, a sensing transistor SENT, and a storage capacitor Cst.

The light emitting element ED may include an anode electrode and a cathode electrode, and may include a light emitting layer positioned between the anode electrode and the cathode electrode.

The driving transistor DRT is a transistor for driving the light emitting element ED, and may include a first node N1, a second node N2, and a third node N3.

The first node N1 of the driving transistor DRT may be a gate node of the driving transistor DRT, and may be electrically connected with a source node or a drain node of the scan transistor SCT. The second node N2 of the driving transistor DRT may be a source node or a drain node of the driving transistor DRT, and may be electrically connected to the anode electrode of the light emitting element ED. The third node N3 of the driving transistor DRT may be electrically connected with a pixel high-potential voltage line DVL supplying a pixel high-potential voltage EVDD.

The scan transistor SCT may be controlled by a scan signal SC, which is a type of gate signal, and may be connected between the first node N1 of the driving transistor DRT and the data line DL. In other words, the scan transistor SCT may be turned on or off according to the scan signal SC supplied from the scan signal line SCL, which is a type of the gate line GL, controlling the connection between the data line DL and the first node N1 of the driving transistor DRT.

The sensing transistor SENT is electrically connected between the second node N2 of the driving transistor DRT and the reference voltage line RVL, and the sensing signal line SENL which is a type of the gate line GL is connected to the gate node. The sensing transistor SENT is operated according to the sensing signal SE supplied through the sensing signal line SENL. Therefore, when the sensing signal SE of the turn-on level is applied, the voltage of the second node N2 of the driving transistor DRT may be transmitted through the reference voltage line RVL.

The gate nodes of the scan transistor SCT and the sensing transistor SENT may be commonly connected to one gate line GL or may be connected to different gate lines GL. Here, the structure in which the scan transistor SCT and the sensing transistor SENT are connected to the scan signal line SCL and the sensing signal line SENL, respectively, is illustrated as an example, and in this case, the scan transistor SCT and the sensing transistor SENT may be independently controlled by the scan signal SC and the sensing signal SE transmitted through the scan signal line SCL and the sensing signal line SENL.

Here, when the scan transistor SCT and the sensing transistor SENT are n-type transistors, the turn-on level voltage of the scan signal SC and the sensing signal SE may be a high level voltage. On the other hand, when the scan transistor SCT and the sensing transistor SENT are p-type transistors, the turn-on level voltage of the scan signal SC and the sensing signal SE may be a low level voltage. Hereinafter, an example is described in which the scan transistor SCT and the sensing transistor SENT are n-type transistors. Accordingly, the turn-on level voltage is exemplified as a high-level voltage.

The storage capacitor Cst may be electrically connected between the first node N1 and second node N2 of the driving transistor DRT. The storage capacitor Cst may be charged with the quantity of electric charge corresponding to the voltage difference between both ends thereof and may serve to maintain the voltage difference between both ends for a predetermined time. Accordingly, during the predetermined frame time, the corresponding subpixel SP may emit light.

In this case, the time during which the light emitting element ED emits light in one frame period may be referred to as an emission period. The emission period may be determined according to the operation of the element constituting the subpixel circuit SPC, and may be determined by the scan signal SC controlling the scan transistor SCT and the sensing signal SE controlling the sensing transistor SENT.

The brightness of the subpixel SP is proportional to the driving current flowing through the light emitting element ED, and the driving current is greatly affected by the threshold voltage of the driving transistor DRT.

Referring to FIG. 6, in the display driving period in which image data is displayed in the 3D display device 100 of the disclosure, scan transistors SCT connected to subpixels in the row direction is typically driven so that subpixels in the row direction may be scanned sequentially. To this end, the scan signals SC adjacent to each other in the display driving period typically have the same length of the on-level period and different phases of the on-level period.

Further, gate signals adjacent to each other may overlap each other by half so that the voltage between the first node N1 and the second node N2 of the driving transistor DRT is simultaneously programmed.

Each frame in which an image is displayed through the display panel 110 may be distinguished by the vertical synchronization signal Vsync. Accordingly, the start time of one frame in which an image is displayed may be determined by the vertical synchronization signal Vsync.

One subpixel SP positioned in the nth row may be driven through the programming period PP and the emission period PE in one frame. The programming period PP is a period for programming a voltage between the first node N1 as the gate node of the driving transistor DRT and the second node N2 as the source node according to a designated gray scale.

During the programming period PP, the scan transistor SCT and the sensing transistor SENT may be sequentially turned on. While both the scan transistor SCT and the sensing transistor SENT are turned on in the programming period PP, a data voltage Vdata may be applied to the first node N1 of the driving transistor DRT.

To this end, the scan signal SC and the sensing signal SE may be shifted while the lengths of the on-level periods are the same, and the on-level periods overlap each other by half. Here, in the phase of the on-level period, the scan signal SC precedes the sensing signal SE.

In the programming period PP, the data driving circuit 130 may be turned on in the on-level Lon period of the sensing signal SE to transfer the data voltage Vdata.

The emission period PE is a period in which a driving current flows through the driving transistor DRT with a voltage between the first node N1 and the second node N2 of the driving transistor DRT programmed in the programming period PP to emit light.

Here, the emission period PE may be determined by the sensing signal SE. During the emission period PE, the scan signal SC and the sensing signal SE are maintained at an off level Loff, and as a result, both the scan transistor SCT and the sensing transistor SENT are turned off.

When the 3D display device 100 includes the subpixel SP having such a structure, the sensing signal SE generated by the gate driving circuit 120 may be used as the emission control signal ECS.

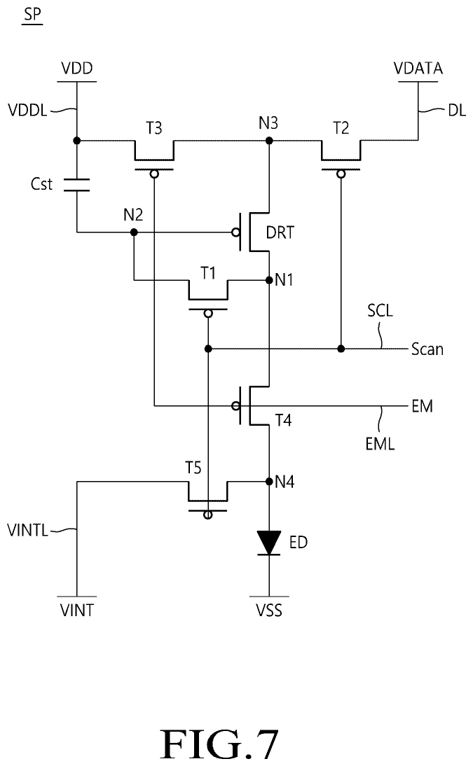

FIG. 7 is a view illustrating an equivalent circuit of another subpixel that may be included in a 3D display device according to embodiments of the disclosure.

Referring to FIG. 7, the 3D display device 100 according to embodiments of the disclosure may adopt an integrated structure of a scan signal SC and an emission signal EM to compensate for a threshold voltage and a voltage drop IR drop of the driving transistor DRT.

As described above, when the subpixel SP may be driven by one scan signal SC and one emission signal EM, the number of the plurality of horizontal signal lines including gate lines GL disposed on the display panel 110 may be reduced, thereby enhancing the stretchable characteristics of the 3D display device 100.

After being initialized with the data voltage Vdata, the subpixel SP may sense the threshold voltage of the driving transistor DRT to be driven by an internal compensation method.

The second node N2 of the driving transistor DRT is a node corresponding to the gate node (also referred to as a gate electrode), and may be electrically connected to the storage capacitor Cst and the first transistor T1.

The first node N1 of the driving transistor DRT may be the drain node (also referred to as a drain electrode) or the source node (also referred to as a source electrode), may be electrically connected to the source node or the drain node of the first transistor T1, and may be electrically connected to the source node or the drain node of the fourth transistor T4.

The third node N3 of the driving transistor DRT may be the source node or the drain node, may be electrically connected to the source node or the drain node of the second transistor T2, and may be electrically connected to the source node or the drain node of the third transistor T3.

The driving transistor DRT may be turned on according to the voltage applied to the second node N2 that is the gate node, and supply a current to the light emitting element ED to emit light.

The first transistor T1 may be electrically connected between the first node N1 and the second node N2 of the driving transistor DRT. Further, the first transistor T1 may be controlled by the scan signal SC supplied through the scan signal line SCL.

The second transistor T2 may be electrically connected between the third node N3 of the driving transistor DRT and the data line DL, and may be controlled by the scan signal SC supplied through the scan signal line SCL.

The third transistor T3 may be electrically connected between the pixel high-potential voltage line DVL supplying the pixel high-potential voltage EVDD and the third node N3 of the driving transistor DRT, and may be controlled by the emission signal EM supplied through the emission signal line EML.

If the emission signal EM of the turn-on level is applied through the emission signal line EML, the third transistor T3 applies the pixel high-potential voltage EVDD to the third node N3 of the driving transistor DRT.

The fourth transistor T4 may be electrically connected between the first node N1 of the driving transistor DRT and the anode electrode of the light emitting element ED. Further, the fourth transistor T4 may be controlled by the emission signal EM supplied through the emission signal line EML. The emission signal line EML may be a type of gate line GL.

The fourth transistor T4 may turn off the light emitting element ED by blocking the current applied to the light emitting element ED if the emission signal EM of the turn-off level is applied through the emission signal line EML.

If the emission signal EM of the turn-on level is applied through the emission signal line EML, the third transistor T3 and the fourth transistor T4 may transfer a driving current flowing through the third node N3, the first node N1, and the fourth node N4 to the light emitting element ED so that the light emitting element ED emits light.

Since the third transistor T3 and the fourth transistor T4 control the emission timing of the light emitting element ED, they may be referred to as emission control transistors.

The fifth transistor T5 may be controlled by the scan signal SC and may be electrically connected between the initialization voltage line VINTL and the anode electrode of the light emitting element ED.

If the scan signal SC of the turn-on level is applied through the scan signal line SCL, the fifth transistor T5 may apply the initialization voltage VINT to the anode electrode of the light emitting element ED or may initialize the node (i.e., the first node N1) between the driving transistor DRT and the fourth transistor T4.

According to an embodiment, the subpixel SP may further include a transistor connected to the gate electrode (e.g., the second node N2) of the driving transistor DRT to initialize the gate voltage of the driving transistor DRT.

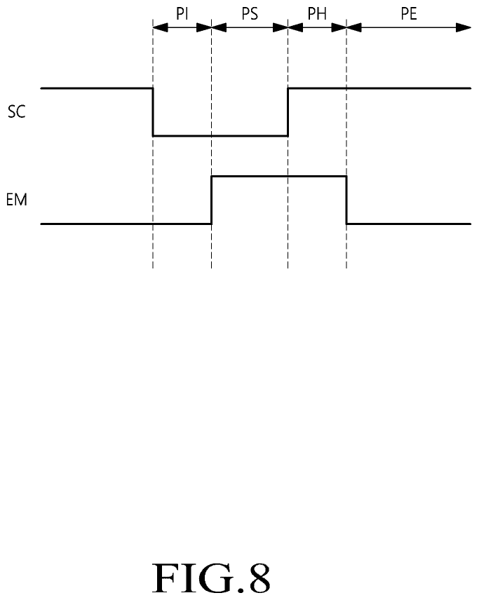

FIG. 8 is an example signal waveform view illustrating an operation of the subpixel of FIG. 7 according to one embodiment.

Referring to FIG. 8, the period of one frame in which each subpixel SP of the 3D display device 100 is driven according to embodiments of the disclosure may include an initialization period PI, a sampling period PS, a holding period PH, and an emission period PE.

The initialization period PI is a period in which voltages of the second node N2 and the third node N3 of the driving transistor DRT are initialized.

During the initialization period PI, each of the scan signal SC and the emission signal EM has a turn-on level voltage. Here, since the first to fifth transistors T1 to T5 are p-type transistors, the turn-on level voltage may be a low level voltage and the turn-off level voltage may be a high level voltage. Hereinafter, the turn-on level voltage is referred to as a low level voltage, and the turn-off level voltage is also referred to as a high level voltage.

The sampling period PS is a period for detecting and storing the threshold voltage of the driving transistor DRT. During the sampling period PS, the scan signal SC has a turn-on level voltage and the emission signal EM has a turn-off level voltage.

For example, while the scan signal SC for turning on the first transistor T1 and the second transistor T2 through the scan signal line SCL is applied in the sampling period PS, the second node N2, which is the gate node of the driving transistor DRT, has a voltage obtained by subtracting the threshold voltage of the driving transistor DRT from the data voltage Vdata. Here, the difference between the absolute values of the data voltage Vdata and the threshold voltage of the driving transistor may be referred to as a tracking voltage.

Through the sampling period PS, the potential of the second node N2 rises and is saturated with a voltage (tracking voltage) having a magnitude corresponding to the voltage obtained by subtracting the threshold voltage of the driving transistor DRT from the data voltage Vdata.

In other words, a potential difference between the gate and source of the driving transistor DRT through the sampling period PS, i.e., a voltage difference between the second node N2 and the third node N3 may correspond to the magnitude of the threshold voltage.

In this case, the initialization period PI and the sampling period PS may be a sensing period in which the threshold voltage of the driving transistor DRT is sensed.

The holding period PH is a step (period) before starting the emission period PE. During the holding period PH, the scan signal SC and the emission signal EM have a turn-off level voltage.

The emission period PE is a period in which the light emitting element ED emits light. During the emission period PE, the scan signal SC has a turn-off level voltage and the emission signal EM has a turn-on level voltage, so that a path through which a current may flow to the light emitting element ED may be created.

In this case, the emission period PE may be determined according to the operation of the element constituting the subpixel SP. Here, the scan signal SC and the emission signal EM may correspond to the emission control signal ECS.

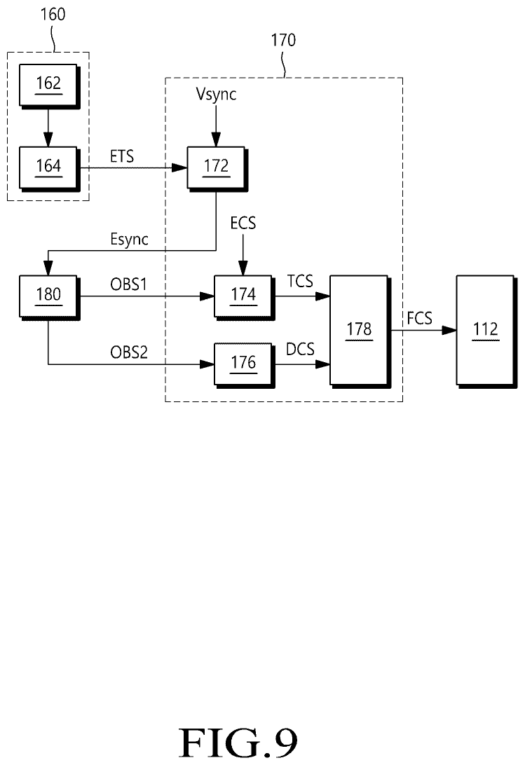

FIG. 9 is a block diagram illustrating a detailed system configuration of a 3D display device according to embodiments of the disclosure.

Referring to FIG. 9, the 3D display device 100 according to embodiments of the disclosure may include a gaze detector 160, a focus control circuit 170, and an object controller 180.

The gaze detector 160 may include a camera 162 capturing the user's eyeball(s) 10, and an eye-tracking circuit 164 that detects a gaze from the user's eye image captured by the camera 162 and generates a gaze detection signal ETS.

The focus control circuit 170 may include a gaze synchronization circuit 172, an object timing control circuit 174, an object depth control circuit 176, and a lens controller 178.

The gaze synchronization circuit 172 synchronizes the gaze detection signal ETS transmitted from the gaze detector 160 with the vertical synchronization signal Vsync to generate a gaze synchronization signal Esync.

The object controller 180 may generate a first object information signal OBS1 including position information of an object to which the user's gaze is directed and a second object information signal OBS2 including depth information of the object displayed on the display panel 110 using the gaze synchronization signal Esync transmitted from the gaze synchronization circuit 172.

In this case, the depth information of the object is information indicating a sense of distance between the object that the user gazes at and the user.

The object timing control circuit 174 may generate a timing control signal TCS for determining the timing of changing the focus of the variable focus lens 112 according to the position of the object that the user gazes at based on the emission control signal ECS and the first object information signal OBS1 transmitted from the object controller 180.

In this case, the emission control signal ECS is a signal that may define the emission period PE of the display panel 110 and may vary according to the circuit configuration of the subpixel SP. For example, the scan signal SC and the sensing signal SE may be the emission control signal ECS in the subpixel SP of the 3T1C structure illustrated in FIG. 5, and may be the scan signal SC and the emission signal EM in the subpixel SP of the 6T1C structure illustrated in FIG. 7. In short, the emission control signal ECS may be a gate signal for defining the emission period in the frame.

Further, the object depth control circuit 176 may generate a depth control signal DCS that controls the depth of the object based on the second object information signal OBS2 transmitted from the object controller 180.

The lens controller 178 may generate a focus control signal FCS for controlling the focus of the variable focus lens 112 using the timing control signal TCS and the depth control signal DCS.

In this case, the focus control signal FCS may be configured to determine the emission period PE and the non-emission period of the display panel 110 so that the focus change timing according to the user's gaze is included in the non-emission period.

Therefore, the 3D display device 100 of the disclosure may reduce issues such as dizziness, eye fatigue, and vomiting caused by vergence accommodation conflict (VAC) in the process of changing the focus on the user's gaze at the object.

As described above, the gaze detector 160, the focus control circuit 170, and the object controller 180 may be included in the timing controller 140 of the 3D display device 100, or may be separately formed on the printed circuit board in the form of an integrated circuit.

The 3D display device 100 of the disclosure may change the focus by controlling the thickness of the variable focus lens 112 according to the depth of the object to which the user's gaze is directed among objects displayed through the display panel 110.

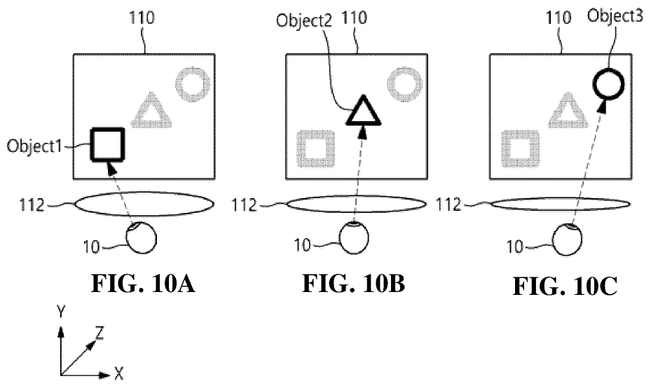

FIG. 10 is a conceptual view illustrating a case in which a variable focus lens is controlled according to a depth of an object to which the user's gaze is directed in a 3D display device according to one embodiment of the disclosure.

Referring to FIG. 10, the 3D display device 100 of the disclosure may change the focus of the user's eyeball 10 by controlling the variable focus lens 112 when the depth of the object gazed at by the user's eyeball 10 varies.

In this case, when the horizontal direction of the display panel 110 is defined as the X direction and the vertical direction as the Y direction, the depth of the object may mean a distance in the Z direction in which the user views the image through the display panel 110.

For example, when an object is displayed to be positioned between the display panel 110 and the user's eyeball 10, it may be referred to as a near object Object1, when an object is displayed to be positioned on the surface of the display panel 110, it may be referred to as a middle-distance object Object2, and when an object is displayed to be positioned on a rear surface of the display panel 110, it may be referred to as a far object Object3.

Therefore, when the user's gaze gazes at the near Object1, the thickness of the variable focus lens 112 may be increased to a first thickness to control the user's gaze to correspond to the near focus (the case of FIG. 10A). Thus, the state of the variable focus lens 112 is changed to the first thickness.

Further, when the user's gaze is directed to the middle-distance object Object2, the thickness of the variable focus lens 112 may be maintained as an intermediate value (e.g., a second thickness that is less than the first thickness) to be controlled to correspond to a middle-distance focus (the case of FIG. 10B). Thus, the state of the variable focus lens 112 is changed to the second thickness. Lastly, when the user's gaze is directed to the far object Object3, the thickness of the variable focus lens 112 may be reduced to a third thickness to control the user's gaze to correspond to the far focus (the case of FIG. 10C). Thus, the state of the variable focus lens 112 is changed to the third thickness.

In this case, the focus control signal FCS is applied according to the timing when the user's gaze moves between the near object Object1, the middle-distance object Object2, and the far object Object3, and the thickness of the variable focus lens 112 may be adjusted in the non-emission period of the frame.

Meanwhile, in the 3D display device 100 of the disclosure, the emission period PE in which the display panel 110 emits light may be controlled considering the type or power of the image.

For example, the 3D display device 100 may be driven to emit light for a short time using a global shutter method or a rolling shutter method.

The global shutter method is a method of allowing all subpixels to simultaneously emit light after writing the data voltage Vdata in the non-emission period for all subpixels included in the display panel 110, and the rolling shutter method is a method of allowing the subpixels in rows in which the data voltage Vdata is written to sequentially emit light while sequentially writing the data voltage Vdata in each row.

The display driving method of the disclosure may be applied to both the global shutter method and the rolling shutter method.

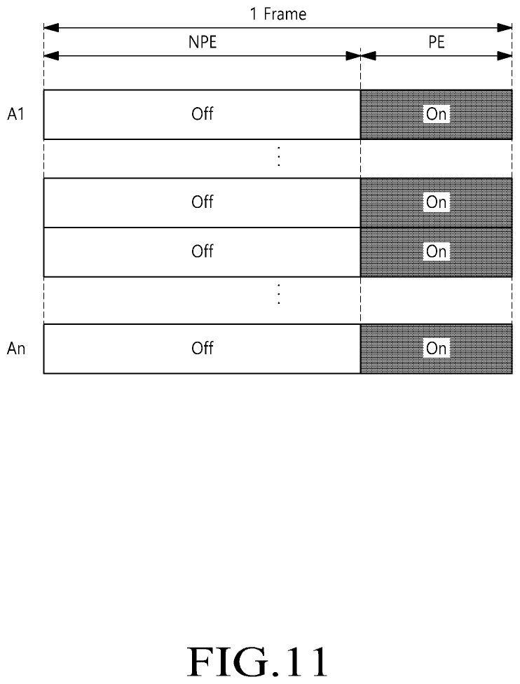

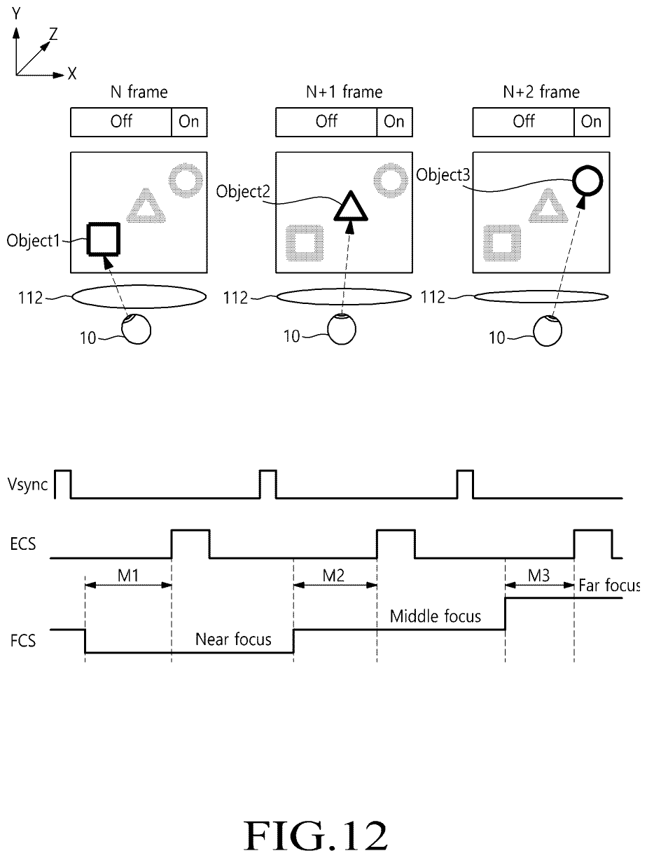

FIG. 11 is a signal flowchart illustrating a case in which a 3D display device operates in a global shutter method according to embodiments of the disclosure, and FIG. 12 is an example view illustrating a method for controlling a focus when a 3D display device operates in a global shutter method according to embodiments of the disclosure.

Referring to FIGS. 11 and 12, in the 3D display device 100 according to embodiments of the disclosure, the display panel 110 may be divided into n areas A1 to An.

In this case, the subpixels SP disposed in all areas A1 to An of the display panel 110 may have a non-emission period NPE having fixed time intervals from the start time of one frame, and an emission period PE having the same time interval from the end point of the non-emission period NPE.

For example, 80% of the time of one frame period may be allocated as the non-emission period NPE, and the remaining 20% may be allocated as the emission period PE, and the emission period PE may be determined by the emission control signal ECS.

As such, in the 3D display device 100 operated in the global shutter method, a time corresponding to 20% of the second half of each frame may be fixed as the emission period PE.

In this case, when the user's gaze moves between the near object Object1, the middle-distance object Object2, or the far object Object3, the focus control signal FCS that controls the variable focus lens 112 according to the movement of the user's gaze may be changed in the non-emission period NPE by avoiding the emission period PE.

As a result, the 3D display device 100 of the disclosure may reduce the vergence accommodation conflict phenomenon in which the image is blurred or the focus becomes unstable due to a focus change by the variable focus lens 112.

In this case, the timing when the focus of the variable focus lens 112 is changed in the non-emission period NPE may have a constant margin between it and the emission period PE.

For example, when the user gazes at the near object Object1 that is at a first distance from the user, the timing of changing the variable focus lens 112 to the near focus may have a first margin M1 up to the emission period PE and, when the user gazes at the middle-distance object Object2 that is at a second distance from the user that is greater than the first distance, the timing of changing the variable focus lens 112 to the middle-distance focus may have a second margin M2 up to the emission period PE. Further, when the user gazes at the far object Object3 that is at a third distance from the user that is greater than the second distance, the timing of changing the variable focus lens 112 to a far focus may have a third margin M3 up to the emission period PE. Responsive to the object being at the first distance from the user, the focus control signal FCS has a first level that causes the variable focus lens 112 to have the first thickness. Responsive to the object being at the second distance from the user, the focus control signal FCS has a second level that is greater than the first level as shown in FIG. 12 which causes the variable focus lens 112 to have the second thickness. Lastly, responsive to the object being at the third distance from the user, the focus control signal FCS has a third level that is greater than the second level which causes the variable focus lens to have the third thickness.

In this case, in order to effectively reduce the vergence accommodation conflict phenomenon, the first margin M1 at the timing of changing the variable focus lens 112 to the near focus may be set to be larger than the second margin M2 at the timing of changing the variable focus lens 112 to the middle-distance focus. Further, the second margin M2 at the time of changing the variable focus lens 112 to the middle-distance focus may be set to be larger than the third margin M3 at the time of changing to the far focus.

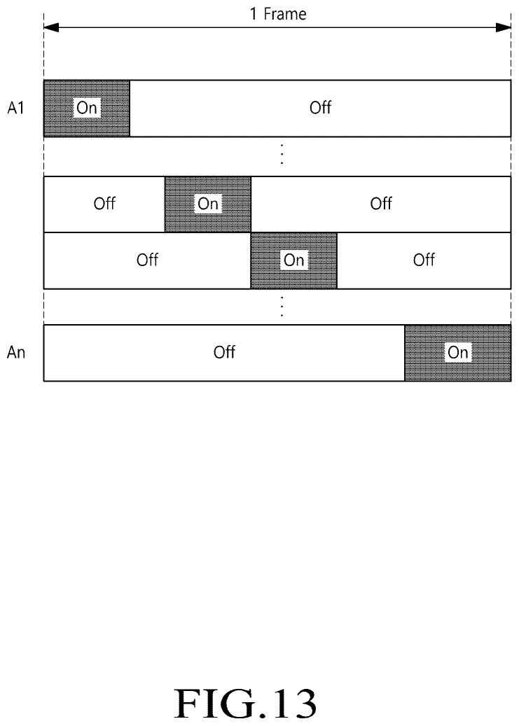

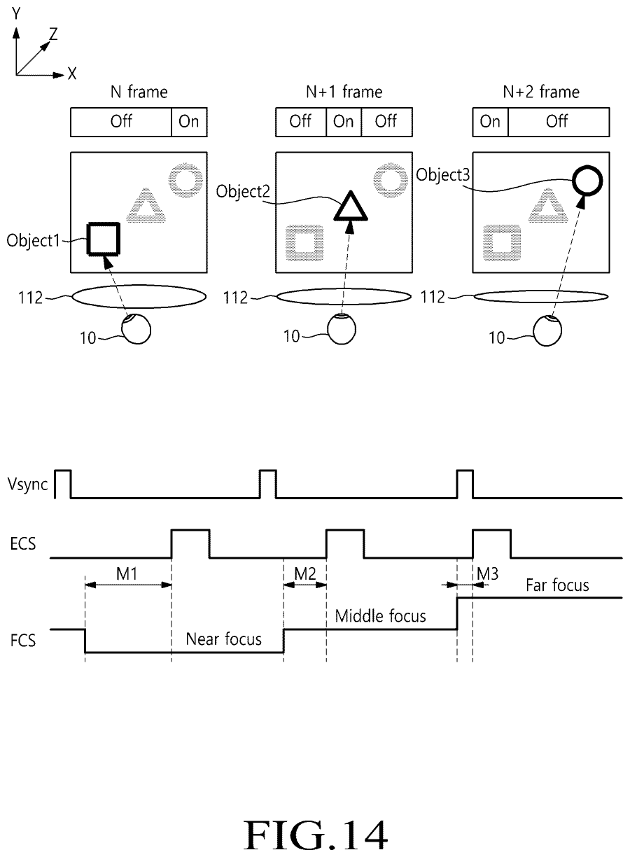

FIG. 13 is a signal flowchart illustrating a case in which a 3D display device operates in a rolling shutter method according to embodiments of the disclosure, and FIG. 14 is an example view illustrating a method for controlling a focus when a 3D display device operates in a rolling shutter method according to embodiments of the disclosure.

Referring to FIGS. 13 and 14, in the 3D display device 100 according to embodiments of the disclosure, the display panel 110 may be divided into n areas A1 to An.

In this case, in the 3D display device 100 of the disclosure, the emission period PE in which the subpixels emit light may be differently positioned for each area A1 to An of the display panel 110. Thus, the data voltage Vdata may be written independently in the subpixel of each area, and the areas in which the data voltage Vdata is written may emit light at different times.

In this case, the emission period PE of each of the areas A1 to An in one frame may be determined by the emission control signal ECS.

As described above, the 3D display device 100 operated in the rolling shutter method may include an emission period PE in which subpixels emit light at a predetermined time for each area A1 to An in each frame.

In this case, when the user's gaze moves between the near object Object1, the middle-distance object Object2, or the far object Object3, the focus control signal FCS that controls the variable focus lens 112 according to the movement of the user's gaze may be changed in the non-emission period NPE by avoiding the emission period PE.

As a result, the 3D display device 100 of the disclosure may reduce the vergence accommodation conflict phenomenon in which the image is blurred or the focus becomes unstable due to a focus change by the variable focus lens 112.

In this case, the timing when the focus of the variable focus lens 112 is changed in the non-emission period NPE may have a constant margin between it and the emission period PE.

For example, when the user gazes at the near object Object1 in the Nth frame that is at a first distance from the user, the timing of changing the variable focus lens 112 to a near focus in the Nth frame may have a first margin M1 up to the emission period PE. Further, when the user gazes at the middle-distance object Object2 in the N+1th frame that is at a second distance from the user that is greater than the first distance, the timing of changing the variable focus lens 112 to a middle-distance focus in the N+1th frame may have a second margin M2 up to the emission period PE. Further, when the user gazes at the far object Object3 in the N+2th frame that is at a third distance from the user that is greater than the second distance, the timing of changing the variable focus lens 112 to a far focus in the N+2th frame may have a third margin M3 up to the emission period PE.

In this case, in order to effectively reduce the vergence accommodation conflict phenomenon, the first margin M1 of changing the variable focus lens 112 to the near focus may be set to be larger than the second margin M2 of changing the variable focus lens 112 to the middle-distance focus. Further, the second margin M2 of changing the variable focus lens 112 to the middle-distance focus may be set to be larger than the third margin M3 of changing to the far focus. Responsive to the object being at the first distance from the user, the focus control signal FCS has a first level which causes the variable focus lens 112 to have the first thickness. Responsive to the object being at the second distance from the user, the focus control signal FCS has a second level that is greater than the first level as shown in FIG. 14 which causes the variable focus lens 112 to have the second thickness. Lastly, responsive to the object being at the third distance from the user, the focus control signal FCS has a third level that is greater than the second level as shown in FIG. 14 which causes the variable focus lens 112 to have the third thickness.

A 3D display device according to an embodiment of the disclosure may be described as follows.

In one embodiment, a display device that displays a three-dimensional image, comprises: a display panel including a plurality of subpixels; a variable focus lens located in a front position of the display panel; an optical lens located in a front position of the variable focus lens such that the variable focus lens is between the display panel and the optical lens; a gaze detector configured to detect a user's gaze of the display panel and generate a gaze detection signal based on the detection; an object controller configured to generate an object information signal corresponding to an object displayed on the display panel; and a focus control circuit configured to control a focus of the variable focus lens based on an emission control signal, the gaze detection signal, and the object information signal.

In one embodiment, the object information signal includes position information of the object to which the user's gaze is directed and depth information of the object.

In one embodiment, the plurality of subpixels emit light during an emission period of one frame and the plurality of subpixels do not emit light during a non-emission period of the one frame, and wherein the focus of the variable focus lens is changed during the non-emission period and the changed focus of the variable focus lens is maintained during the emission period.

In one embodiment, the gaze detector includes: a camera configured to capture an image of an eye of the user; and an eye-tracking circuit configured to detect the user's gaze from the eye image and generate the gaze detection signal based on the detection.

In one embodiment, the focus control circuit includes: a gaze synchronization circuit configured to synchronize the gaze detection signal with a vertical synchronization signal and generate a gaze synchronization signal; an object timing control circuit configured to generate a timing control signal that controls a timing of changing the focus of the variable focus lens based on an emission control signal that determines the emission period and a first object information signal transmitted from the object controller; an object depth control circuit configured to generate a depth control signal that controls a depth of the object based on a second object information signal transmitted from the object controller; and a lens controller configured to generate a focus control signal that controls the focus of the variable focus lens using the timing control signal and the depth control signal.

In one embodiment, the object controller generates the first object information signal including position information of the object to which the user's gaze is directed and the second object information signal including depth information of the object using the gaze synchronization signal.

In one embodiment, the focus control signal generated by the focus control circuit includes: a first margin between the focus control signal and the emission period responsive to the object being at a first distance from the user; a second margin between the focus control signal and the emission period that is different from the first margin responsive to the object being at a second distance from the user that is greater than the first distance; and a third margin between the focus control signal and the emission period that is different from the second margin responsive to the object being at a third distance from the user that is greater than the second distance.

In one embodiment, the first margin is larger than the second margin and the second margin is larger than the third margin.

In one embodiment, the first distance indicates that the object is located between the display panel and the user, the second distance indicates that the object is located on a surface of the display panel, and the third distance indicates that the object is located on a rear surface of the display panel.

In one embodiment, a display driving method for driving a display panel including a plurality of subpixels, the display driving method comprising: detecting a user's gaze and generating a gaze detection signal based on the detection; synchronizing the gaze detection signal with a vertical synchronization signal and generating a gaze synchronization signal; generating an object information signal for an object displayed on the display panel using the gaze synchronization signal; and controlling a focus of a variable focus lens during a non-emission period of one frame based on an emission control signal, the gaze detection signal, and the object information signal.

In one embodiment, generating the gaze detection signal includes: capturing an image of an eye of the user, wherein the user's gaze is detected from the image; and generating the gaze detection signal based on the detected user's gaze.

In one embodiment, controlling the focus of the variable focus lens includes: synchronizing the gaze detection signal with the vertical synchronization signal and generating the gaze synchronization signal; generating a timing control signal that controls a timing of changing the focus of the variable focus lens based on an emission control signal that determines an emission period and a first object information signal; generating a depth control signal that controls a depth of the object based on a second object information signal; and generating a focus control signal that controls the focus of the variable focus lens using the timing control signal and the depth control signal.

In one embodiment, the first object information signal includes position information of the object to which the user's gaze is directed using the gaze synchronization signal and the second object information signal includes depth information of the object.

In one embodiment, the focus control signal changes the focus of the variable focus lens during the non-emission period.

In one embodiment, the focus control signal includes: a first margin between the focus control signal and the emission period responsive to the object being at a first distance from the user; a second margin between the focus control signal and the emission period that is different from the first margin responsive to the object being at a second distance from the user that is greater than the first distance; and a third margin between the focus control signal and the emission period that is different from the second margin responsive to the object being at a third distance from the user that is greater than the second distance.

In one embodiment, the first margin is larger than the second margin and the second margin is larger than the third margin.

In one embodiment, the first distance indicates that the object is located between the display panel and the user, the second distance indicates that the object located on a surface of the display panel, and the third distance indicates that the object is located on a rear surface of the display panel.

In one embodiment, a display device that displays a three-dimensional image, the display device comprising: a display panel including a plurality of subpixels that display an object; an optical lens; a variable focus lens between the display panel and the optical lens; and a gaze detector configured to detect a user's gaze of the object displayed by the display panel, wherein a state of the variable focus lens is changed according to the detected user's gaze which changes a focus of the variable focus lens.

In one embodiment, the state of the variable focus lens is a thickness of the variable focus lens, and wherein the thickness is changed to a first thickness responsive to the user's gaze indicating that the object is a first distance from the user, the thickness is changed to a second thickness that is less than the first thickness responsive to the user's gaze indicating that the object is a second distance from the user that is greater than the first distance, and the thickness is changed to a third thickness that is less than the second thickness responsive to the user's gaze indicating that the object is a third distance from the user that is greater than the second distance.

In one embodiment, the display device further comprises: a focus control circuit configured to output a focus control signal to the variable focus lens based on the user's gaze, the state of the variable focus lens changing according to the focus control signal wherein the focus control signal has a first level responsive to the user's gaze indicating that the object is the first distance from the user, wherein the focus control signal has a second level that is greater than the first level responsive to the user's gaze indicating that the object is the second distance from the user, wherein the focus control signal has a third level that is greater than the second level responsive to the user's gaze indicating that the object is the third distance from the user.

In one embodiment, the state of the variable focus lens is changed during a non-emission period of one frame during which the plurality of subpixels do not emit light and the state of the variable focus lens is maintained during an emission period of the one frame during which the plurality of subpixels emit light.

In one embodiment, the focus control signal includes: a first margin between the focus control signal and the emission period responsive to the object being at the first distance from the user; a second margin between the focus control signal and the emission period responsive to the object being at the second distance from the user that is greater than the first distance; and a third margin between the focus control signal and the emission period responsive to the object being at the third distance from the user that is greater than the first distance.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

What is claimed:

1. A display device that displays a three-dimensional image, comprising:
a display panel including a plurality of subpixels;
a variable focus lens located in a front position of the display panel;
an optical lens located in a front position of the variable focus lens such that the variable focus lens is between the display panel and the optical lens;
a gaze detector configured to detect a user's gaze of the display panel and generate a gaze detection signal based on the detection;
an object controller configured to generate an object information signal corresponding to an object displayed on the display panel; and
a focus control circuit configured to control a focus of the variable focus lens based on an emission control signal, the gaze detection signal, and the object information signal.

2. The display device of claim 1, wherein the object information signal includes position information of the object to which the user's gaze is directed and depth information of the object.

3. The display device of claim 1, wherein the plurality of subpixels emit light during an emission period of one frame and the plurality of subpixels do not emit light during a non-emission period of the one frame, and
wherein the focus of the variable focus lens is changed during the non-emission period and the changed focus of the variable focus lens is maintained during the emission period.

4. The display device of claim 1, wherein the gaze detector includes:
a camera configured to capture an image of an eye of the user; and
an eye-tracking circuit configured to detect the user's gaze from the eye image and generate the gaze detection signal based on the detection.

5. The display device of claim 3, wherein the focus control circuit includes:
a gaze synchronization circuit configured to synchronize the gaze detection signal with a vertical synchronization signal and generate a gaze synchronization signal;
an object timing control circuit configured to generate a timing control signal that controls a timing of changing the focus of the variable focus lens based on an emission control signal that determines the emission period and a first object information signal transmitted from the object controller;
an object depth control circuit configured to generate a depth control signal that controls a depth of the object based on a second object information signal transmitted from the object controller; and
a lens controller configured to generate a focus control signal that controls the focus of the variable focus lens using the timing control signal and the depth control signal.

6. The display device of claim 5, wherein the object controller generates the first object information signal including position information of the object to which the user's gaze is directed and the second object information signal including depth information of the object using the gaze synchronization signal.

7. The display device of claim 5, wherein the focus control signal generated by the focus control circuit includes:
a first margin between the focus control signal and the emission period responsive to the object being at a first distance from the user;
a second margin between the focus control signal and the emission period that is different from the first margin responsive to the object being at a second distance from the user that is greater than the first distance; and
a third margin between the focus control signal and the emission period that is different from the second margin responsive to the object being at a third distance from the user that is greater than the second distance.

8. The display device of claim 7, wherein the first margin is larger than the second margin and the second margin is larger than the third margin.

9. The display device of claim 7, wherein the first distance indicates that the object is located between the display panel and the user, the second distance indicates that the object is located on a surface of the display panel, and the third distance indicates that the object is located on a rear surface of the display panel.

10. A display driving method for driving a display panel including a plurality of subpixels, the display driving method comprising:
detecting a user's gaze and generating a gaze detection signal based on the detection;
synchronizing the gaze detection signal with a vertical synchronization signal and generating a gaze synchronization signal;
generating an object information signal for an object displayed on the display panel using the gaze synchronization signal; and
controlling a focus of a variable focus lens during a non-emission period of one frame based on an emission control signal, the gaze detection signal, and the object information signal.

11. The display driving method of claim 10, wherein generating the gaze detection signal includes:
capturing an image of an eye of the user, wherein the user's gaze is detected from the image; and
generating the gaze detection signal based on the detected user's gaze.

12. The display driving method of claim 10, wherein controlling the focus of the variable focus lens includes:
synchronizing the gaze detection signal with the vertical synchronization signal and generating the gaze synchronization signal;
generating a timing control signal that controls a timing of changing the focus of the variable focus lens based on an emission control signal that determines an emission period and a first object information signal;
generating a depth control signal that controls a depth of the object based on a second object information signal; and
generating a focus control signal that controls the focus of the variable focus lens using the timing control signal and the depth control signal.

13. The display driving method of claim 12, wherein the first object information signal includes position information of the object to which the user's gaze is directed using the gaze synchronization signal and the second object information signal includes depth information of the object.

14. The display driving method of claim 12, wherein the focus control signal changes the focus of the variable focus lens during the non-emission period.

15. The display driving method of claim 14, wherein the focus control signal includes:
a first margin between the focus control signal and the emission period responsive to the object being at a first distance from the user;
a second margin between the focus control signal and the emission period that is different from the first margin responsive to the object being at a second distance from the user that is greater than the first distance; and
a third margin between the focus control signal and the emission period that is different from the second margin responsive to the object being at a third distance from the user that is greater than the second distance.

16. The display driving method of claim 15, wherein the first margin is larger than the second margin and the second margin is larger than the third margin.

17. The display driving method of claim 16, wherein the first distance indicates that the object is located between the display panel and the user, the second distance indicates that the object located on a surface of the display panel, and the third distance indicates that the object is located on a rear surface of the display panel.

18. A display device that displays a three-dimensional image, the display device comprising:
a display panel including a plurality of subpixels that display an object;
an optical lens;
a variable focus lens between the display panel and the optical lens; and
a gaze detector configured to detect a user's gaze of the object displayed by the display panel,
wherein a state of the variable focus lens is changed according to the detected user's gaze which changes a focus of the variable focus lens.

19. The display device of claim 18, wherein the state of the variable focus lens is a thickness of the variable focus lens, and
wherein the thickness is changed to a first thickness responsive to the user's gaze indicating that the object is a first distance from the user, the thickness is changed to a second thickness that is less than the first thickness responsive to the user's gaze indicating that the object is a second distance from the user that is greater than the first distance, and the thickness is changed to a third thickness that is less than the second thickness responsive to the user's gaze indicating that the object is a third distance from the user that is greater than the second distance.

20. The display device of claim 19, further comprising:
a focus control circuit configured to output a focus control signal to the variable focus lens based on the user's gaze, the state of the variable focus lens changing according to the focus control signal,
wherein the focus control signal has a first level responsive to the user's gaze indicating that the object is the first distance from the user,
wherein the focus control signal has a second level that is greater than the first level responsive to the user's gaze indicating that the object is the second distance from the user,
wherein the focus control signal has a third level that is greater than the second level responsive to the user's gaze indicating that the object is the third distance from the user.
